(19) United States
(12) Patent Application Publication
(10) Pub. No.: US 2026/0204021 A1
(43) Pub. Date: Jul. 16, 2026

(54) DYNAMIC LEVEL OF DETAIL

(71) Applicant: thinAir Technologies, Inc., Covington, LA (US)

(72) Inventor: Jeremey Charbonnet, Covington, LA (US)

(21) Appl. No.: 19/444,853

(22) Filed: Jan. 9, 2026

Related U.S. Application Data
(60) Provisional application No. 63/745,719, filed on Jan. 15, 2025.

(51) Int. Cl. G06T 17/20

(52) U.S. Cl. CPC G06T 17/20; G06T 2210/36

(57) ABSTRACT

In one implementation, a method of rendering objects is performed by a device including one or more processors and non-transitory memory. The method includes storing object data for a plurality of objects including storing first object data for a first object of the plurality of objects including a plurality of levels of detail respectively associated with a plurality of number of polygons. The method includes determining a polygon limit. The method includes selecting a first level of detail for the first object associated with a first number of polygons. The method includes, in response to determining that a sum of the number of polygons associated with a currently selected level of detail for each of the plurality of objects is greater than the polygon limit, selecting a second level of detail for the first object associated with a second number of polygons less than the first number of polygons. The method includes, in response to determining that the sum of the number of polygons associated with the currently selected level of detail for each of the plurality of objects is less than the polygon limit, rendering the plurality of objects with the currently selected level of detail.

### CROSS-REFERENCES TO RELATED APPLICATIONS

This application claims priority to U.S. Provisional Patent App. No. 63/745,719, filed on Jan. 15, 2025, which is hereby incorporated by reference in its entirety.

### TECHNICAL FIELD

The present disclosure generally relates to systems, methods, and devices of displaying a virtual environment.

### BACKGROUND

In various implementations, rendering a virtual environment for display includes rendering multiple objects at different depths.

### BRIEF DESCRIPTION OF THE DRAWINGS

So that the present disclosure can be understood by those of ordinary skill in the art, a more detailed description may be had by reference to aspects of some illustrative implementations, some of which are shown in the accompanying drawings.

FIGS. 1A-1H illustrate a virtual environment during various time periods in accordance with some implementations.

FIG. 2 is a flowchart representation of a method of rendering objects in accordance with some implementations.

FIG. 3 is a block diagram of an example electronic device in accordance with some implementations.

In accordance with common practice the various features illustrated in the drawings may not be drawn to scale. Accordingly, the dimensions of the various features may be arbitrarily expanded or reduced for clarity. In addition, some of the drawings may not depict all of the components of a given system, method or device. Finally, like reference numerals may be used to denote like features throughout the specification and figures.

### SUMMARY

Various implementations disclosed herein include devices, systems, and methods for rendering a virtual environment. In various implementations, the method is performed by a device having one or more processors and non-transitory memory. The method includes storing object data for a plurality of objects including storing first object data for a first object of the plurality of objects including a plurality of levels of detail respectively associated with a plurality of number of polygons. The method includes determining a polygon limit. The method includes selecting a first level of detail for the first object associated with a first number of polygons. The method includes, in response to determining that a sum of the number of polygons associated with a currently selected level of detail for each of the plurality of objects is greater than the polygon limit, selecting a second level of detail for the first object associated with a second number of polygons less than the first number of polygons. The method includes, in response to determining that the sum of the number of polygons associated with the currently selected level of detail for each of the plurality of objects is less than the polygon limit, rendering the plurality of objects with the currently selected level of detail.

In accordance with some implementations, a device includes one or more processors, a non-transitory memory, and one or more programs; the one or more programs are stored in the non-transitory memory and configured to be executed by the one or more processors and the one or more programs include instructions for performing or causing performance of any of the methods described herein. In accordance with some implementations, a non-transitory computer readable storage medium has stored therein instructions, which, when executed by one or more processors of a device, cause the device to perform or cause performance of any of the methods described herein. In accordance with some implementations, a device includes: one or more processors, a non-transitory memory, and means for performing or causing performance of any of the methods described herein.

### DESCRIPTION

Numerous details are described in order to provide a thorough understanding of the example implementations shown in the drawings. However, the drawings merely show some example aspects of the present disclosure and are therefore not to be considered limiting. Those of ordinary skill in the art will appreciate that other effective aspects and/or variants do not include all of the specific details described herein. Moreover, well-known systems, methods, components, devices and circuits have not been described in exhaustive detail so as not to obscure more pertinent aspects of the example implementations described herein.

As noted above, in various implementations, rendering a virtual environment for display includes rendering multiple objects at different depths. In various implementations, as the distance between a rendering perspective and an object increases, the level of detail is decreased. Further, objects at a distance from the rendering perspective greater than a perspective draw distance are not rendered at all.

However, in various implementations, even when the rendering perspective is unchanged, circumstances could lead to a desire to render additional polygons. If the level of detail of objects is based only on distance, the number of rendered polygons for a target frame rate may exceed the rate at which polygons can be rendered and the frame rate drops.

In various implementations, certain objects are associated with other objects in a parent-child relationship. Thus, in various implementations, a first object is a parent object of a second object which is a child object of the first object. When a parent object is transformed (e. g,, moved, rotated, or scaled), the child object is similarly transformed. Thus, three-dimensional coordinates defining the location of the child object may be specified in reference to the parent object rather than the virtual environment.

In various implementations, the level of detail is decreased by decreasing the number of polygons of a mesh of the object. For example, in various implementations, a sphere is rendered with thousands of polygons when rendered close to the rendering perspective, but is rendered as a dodecahedron (with 12 polygons) when rendered far from the rendering perspective.

In various implementations, the level of detail is decreased by decreasing a resolution of a material applied to the mesh of the object. For example, in various implementations, a material with a high resolution is applied when rendered close to the rendering perspective, but is rendered with a low resolution when rendered far from the rendering perspective.

In various implementations, the level of detail of a parent object is decreased by decreasing a number of rendered child objects. For example, in various implementations, a parent object is rendered with all of its child objects when rendered close to the rendering perspective, but is rendered with less than all of its child objects when rendered far from the rendering perspective. Thus, each child object has an object-dependent draw distance. In general, the level of detail of an object can be decreased to zero at an object-dependent draw distance at which the object is no longer rendered.

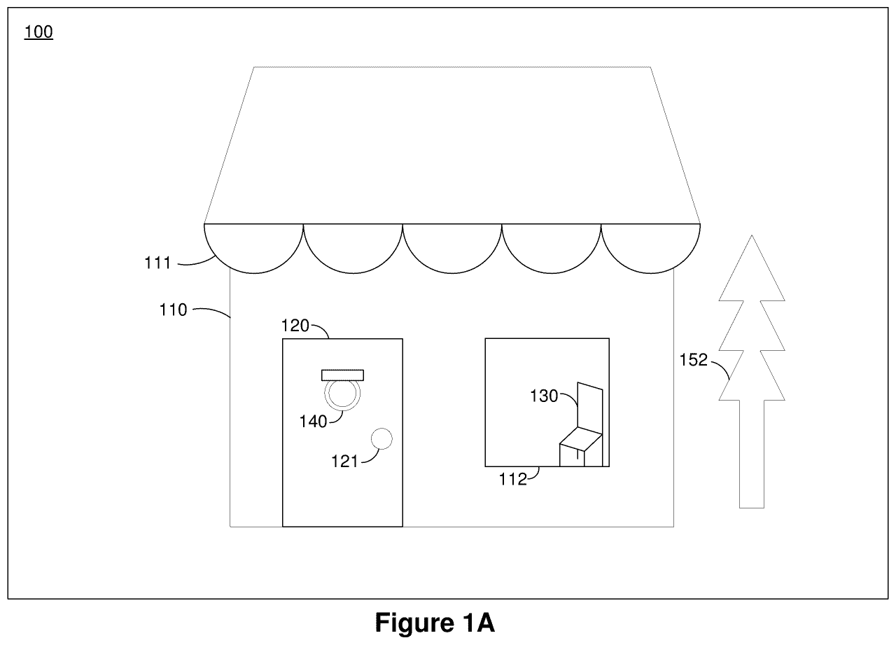

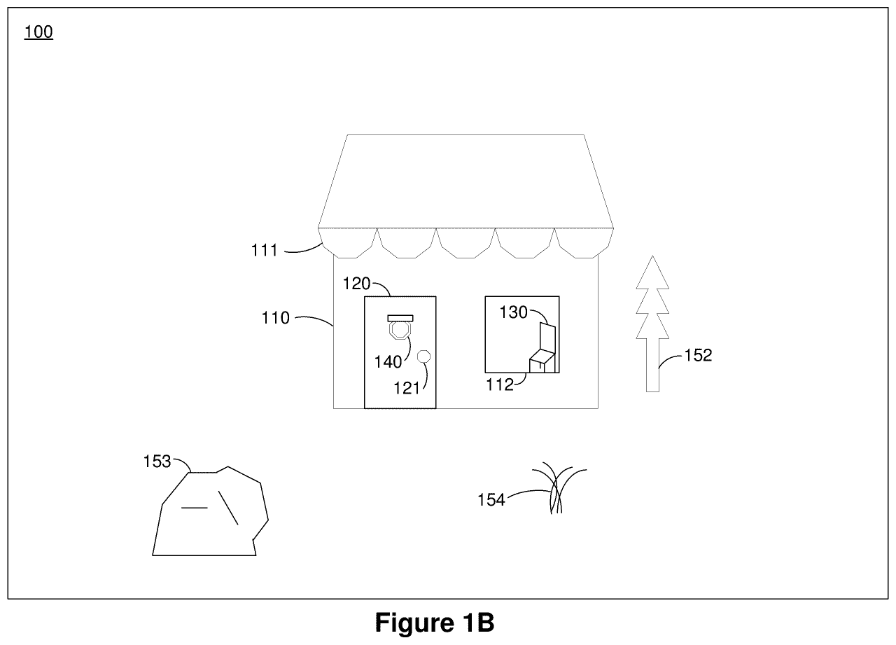

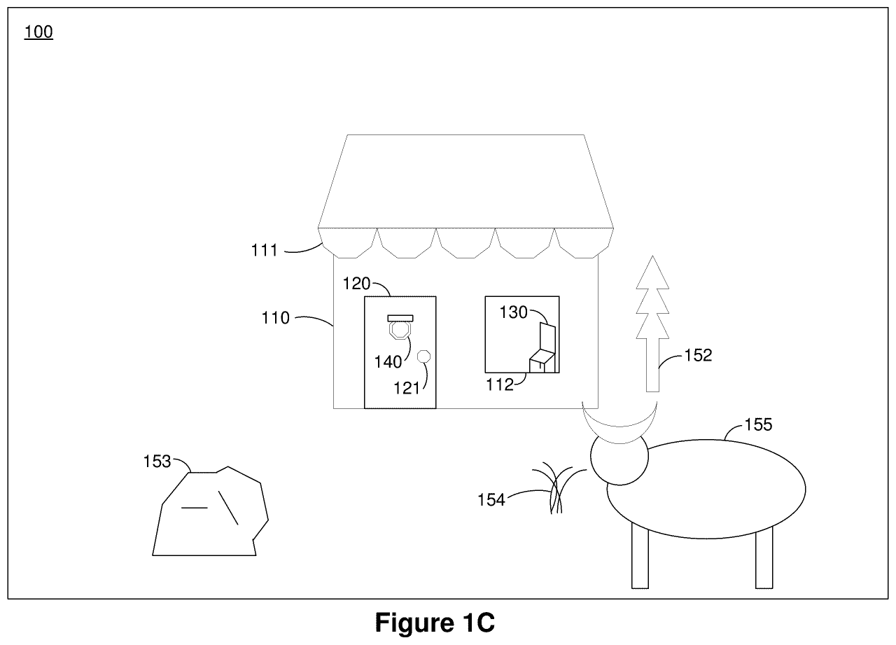

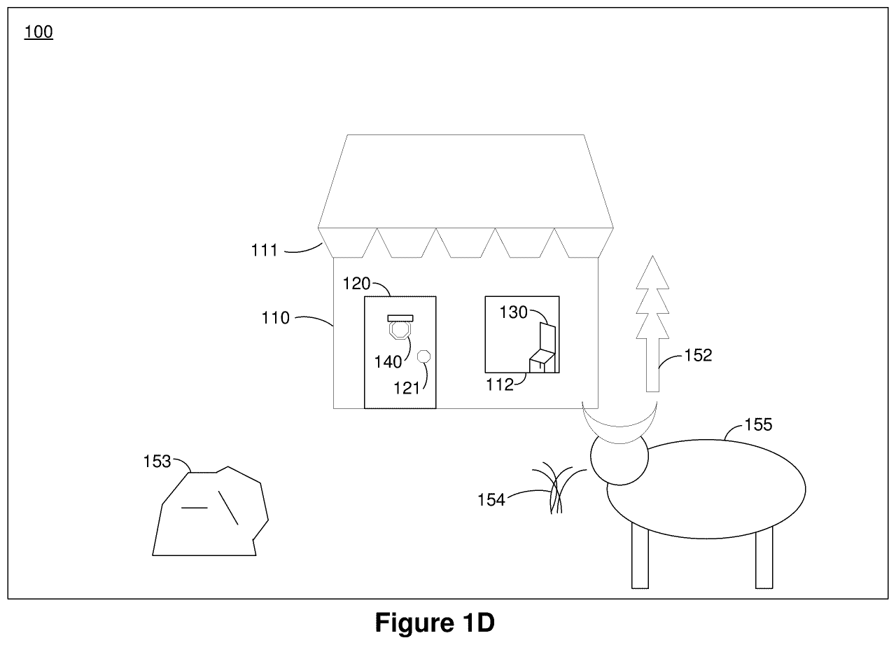

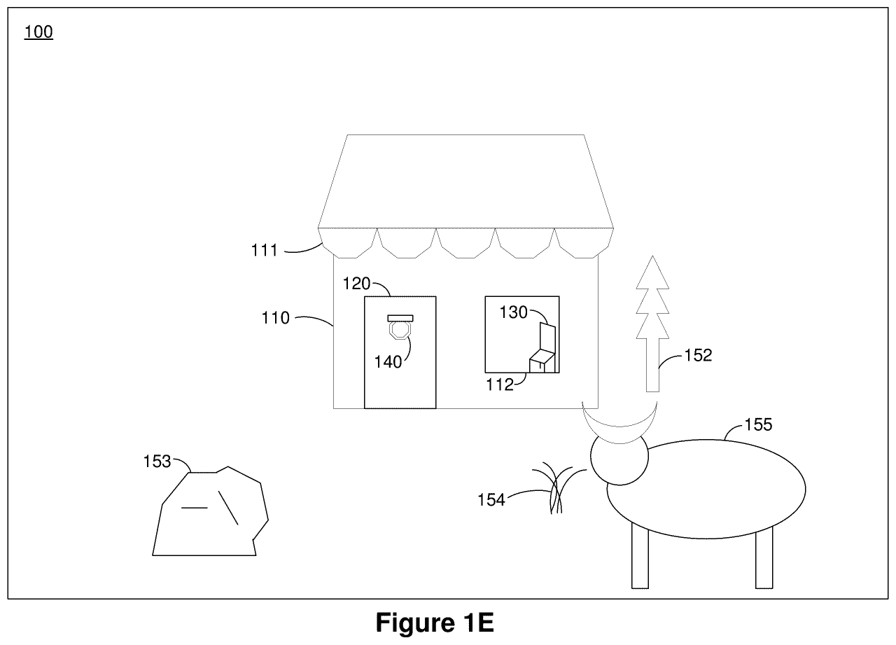

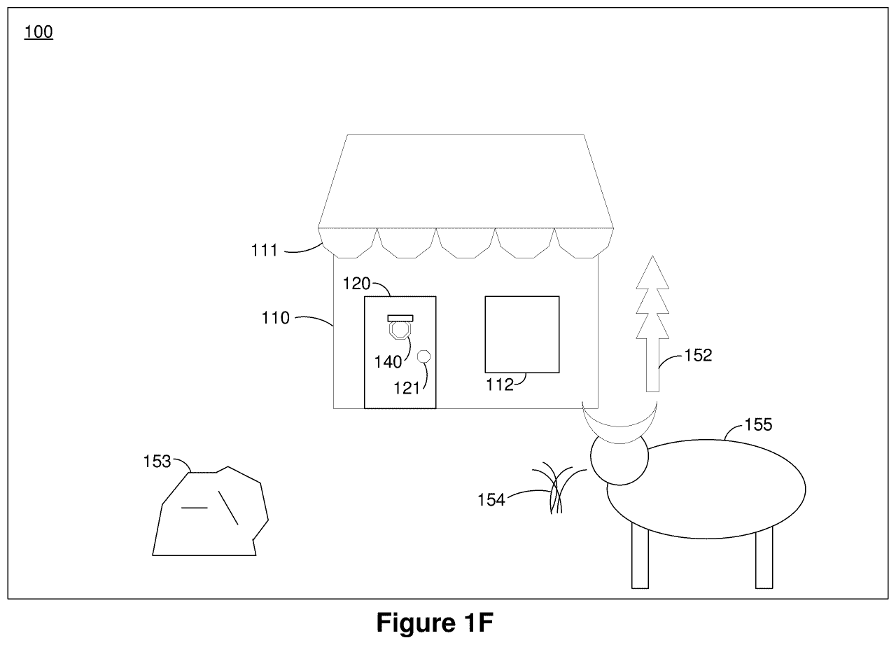

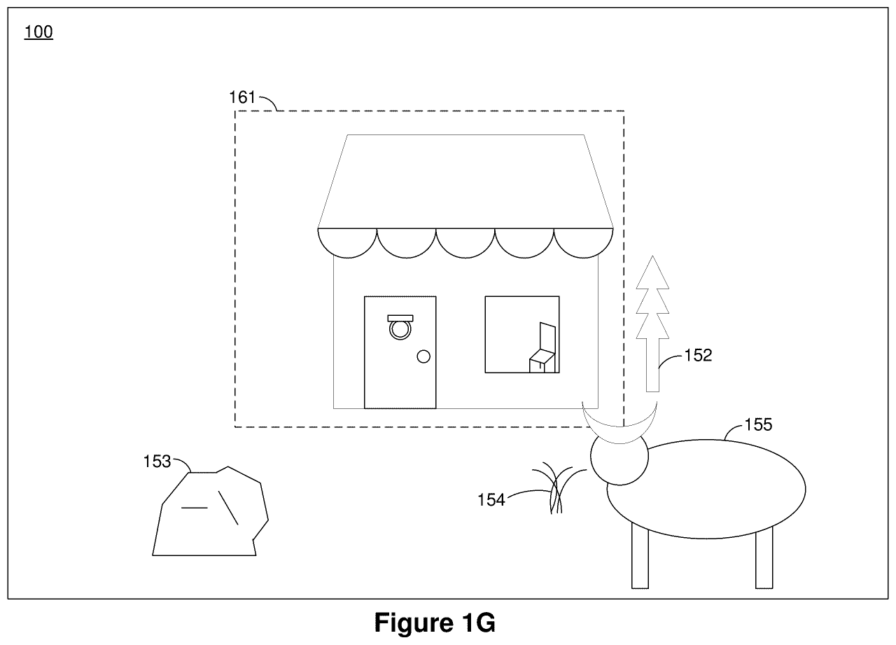

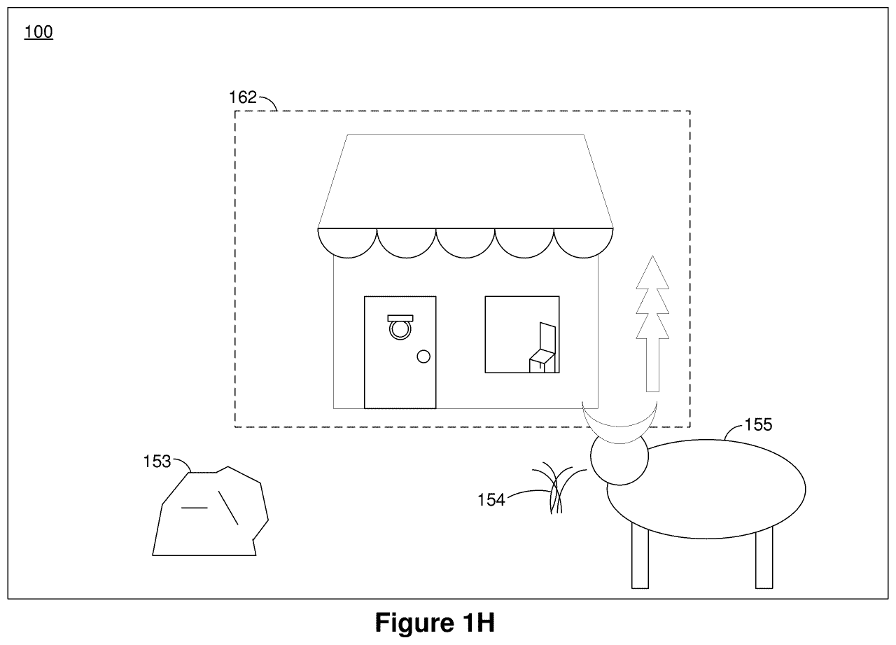

FIGS. 1A-1H illustrate a virtual environment 100 from a rendering perspective displayed, at least in part, by a display of an electronic device. In various implementations, the electronic device includes multiple displays (e.g., a left display positioned in front of a left eye of a user and a right display positioned in front of a right eye of the user) configured to provide a stereoscopic view of the virtual environment 100. For ease of illustration, FIGS. 1A-1H illustrate the virtual environment as presented on a single one of the multiple displays.

FIGS. 1A-1H illustrate the virtual environment 100 during a series of time periods. In various implementations, each time period is an instant, a fraction of a second, a few seconds, a few hours, a few days, or any length of time.

FIG. 1A illustrates the virtual environment 100 during a first time period. During the first time period, the virtual environment 100 includes a house 110 and a tree 152. The house 110 is rendered based on a house object stored in a memory of the electronic device and the tree 152 is rendered based on a tree object stored in the memory of the electronic device. The house object contains multiple meshes with different numbers of polygons for rendering the house 110 at various levels of detail. Each of the meshes of the house object includes polygons for rendering a roof 111 and a window 112. Further, the house object is associated with multiple child objects stored in the memory of the electronic device including a door object and a chair object. During the first time period, the house 110 includes a door 120 rendered based on the door object and a chair 130 rendered based on the chair object. The door object contains multiple meshes with different numbers of polygons for rendering the door 120 at various levels of detail. Some of the meshes of the door object include polygons for rendering a doorknob 121. Further, the door object is associated with knocker object stored in the memory of the electronic device that is a child object of the door object. During the first time period, the door 120 includes a knocker 140 rendered based on the knocker object. The knocker object contains multiple meshes with different numbers of polygons for rendering the knocker 140 at various levels of detail. During the first time period, the house 110, door 120, chair 130, the knocker 140, and tree 152 are rendered at a first (and highest) level of detail. Thus, the roof 111 has round scallops, the doorknob 121 is a circle, and the knocker 140 is a ring.

In various implementations, the house object contains a set of coordinates in a virtual environment coordinate system. Thus, when the user moves the house 110, the set of coordinates in the virtual environment coordinate system are changed. Because the door object and chair object are child objects of the house object, moving the house 110 also moves the door 120 and the chair 130. Similarly, because the knocker object is a child object of the door object, moving the door 120 also moves the knocker 140.

In various implementations, each child object contains a set of coordinates in a parent object coordinate system. Thus, for example, when the user moves the chair 130, a set of coordinates in the house coordinate system are changed. In contrast, when moving the house 110, the set of coordinates of the chair 130 in the house coordinate system are unchanged.

FIG. 1B illustrates the virtual environment 100 during a second time period subsequent to the first time period. Between the first time period and the second time period, a user has moved the rendering perspective farther from the house 110 and the tree 152. From this farther rendering perspective, the virtual environment 100 includes a rock 153 and a grass tuft 154. The rock 153 is rendered based on a rock object stored in the memory of the electronic device. Similarly, the grass tuft 154 is rendered based on a grass tuft object stored in the memory of the electronic device. The rock object contains multiple meshes with different numbers of polygons for rendering the rock 153 at various levels of detail and the grass tuft object contains multiple meshes with different numbers of polygons for rendering the grass tuft 154 are various levels of detail. During the second time period, the rock 153 and the grass tuft 154 are rendered at a first (and highest) level of detail.

In various implementations, the number of polygons that the electronic device can render in a fixed time period is finite. For example, in various implementations, the electronic device can render N polygons a second. At a frame rate of F, each frame can contain N/F polygons on average. Assuming the number of polygons used to render the house 110 and the tree 152 at the first level of detail is N/F and the number of polygons used to render the rock 153 and the grass tuft 154 at the first level of detail is M/F, the number of polygons per frame is (N+M)/F. Because the maximum number of polygons the electronic device can render in a second is N, the frame rate reduces to N/(N+M)×F.

Alternatively, in order to maintain a consistent frame rate and render the meshes of the rock 153 and the grass tuft 154, the number of polygons rendered for the house 110 and the tree 152 are reduced. Anticipating that foreground objects will be introduced when the rendering perspective is moved farther from background objects, in various implementations, the level of detail of an object (e.g., the number of polygons used to render the object) is based on a distance between the rendering perspective and the object. For example, when the distance is less than a first threshold, the object is rendered at a first (and highest) level of detail. When the distance is greater than the first threshold, but less than a second threshold, the object is rendered at a second (and lower) level of detail. When the distance is greater than the second threshold, but less than a third threshold, the object is rendered at a third (and lower) level of detail. When the distance is greater than a rendering threshold, the object is not rendered. In various implementations, the various thresholds are different for different objects. In particular, the rendering threshold may be different for different objects. In various implementations, the rendering threshold may be referred to as a “draw distance.” In various implementations, there is a global rendering threshold (which may be referred to as a “global draw distance”) and any object with a distance from the rendering perspective farther from the global rendering threshold is not rendered.

Thus, during the second time period, as the distance from the rendering perspective to the house 110 and the tree 152 has increased, the house 110 and tree 152 are rendered at a second (and lower) level of detail. At the second level of detail, the house 110 is rendered with a mesh having less polygons than in the first time period of FIG. 1A. Thus, the roof 111 has angled scallops. Further, the door 120 is rendered with a mesh having less polygons than in the second time period of FIG. 1A. Thus, the doorknob 121 is an octagon. Further, the knocker 140 is rendered with a mesh having less polygons than in the first time period of FIG. 1A. Thus, the knocker 140 is an octagonal annulus. Thus, the level of detail of the house 110 is lowered by using a mesh of the house object having fewer polygons and lowering the detail of the rendering of a child object, e.g., the door object. Similarly, the level of detail of the door 120 is lowered by using a mesh of the door object having fewer polygons and lowering the detail of the rendering of a child object, e.g., the knocker object. The level of detail of the knocker 140 is lowered by using a mesh of the knocker object having fewer polygons. Thus, the house 110 (including its child objects) is rendered with fewer polygons.

FIG. 1C illustrates the virtual environment 100 during a third time period subsequent to the second time period. Between the second time period and the third time period, the rendering perspective has not changed, but a cow 155 has been introduced into the virtual environment 100 near the grass tuft 154. The cow 155 is rendered based on a cow object stored in the memory of the electronic device. The cow object contains multiple meshes with different numbers of polygons for rendering the cow 155 at various levels of detail. During the third time period, the cow 155 (being the object closest to the rendering perspective) is rendered at a first (and highest) level of detail.

As mentioned above, in various implementations, the number of polygons that the electronic device can render in a fixed time period is finite. Because the number of polygons used to render the house 110, tree 152, rock 153, and grass tuft 154 has not changed (because their respective distances from rendering perspective has not changed), the additional polygons used to render the cow 155 causes the frame rate to decrease. Thus, the frame rate during the third time period is less than the frame rate during the second time period.

Decreasing the frame rate can negatively affect a user's experience. Accordingly, in various implementations, the distance thresholds used to select the level of detail of objects may be chosen such that the introduction of new objects is unlikely to cause the electronic device to reduce the frame rate because of the number of polygons rendered. For example, in various implementations, during the second time period in FIG. 1B, the number of polygons used to render the house 110 and the tree 152 at the second level of detail is (N−M)/F and the number of polygons used to render the rock 153 and the grass tuft 154 at the first level of detail is M/F. Thus, the number of polygons per frame is N/F. Because the maximum number of polygons the electronic device can render in a second is N, the frame rate is still F. However, assuming the number of polygons used to render the cow at the first level of detail is P, during the third time period of FIG. 1C, the frame rate drops to N/(N+P)×F.

However, in various implementations, during the second time period in FIG. 1B, the number of polygons used to render the house 110 and the tree 152 at the second level of detail is (N−Q)/F and the number of polygons used to render the rock 153 and the grass tuft 154 at the first level of detail is M/F, where Q (the reduction in the number of polygons) is greater than M+P. Thus, the number of polygons per frame is (N+M−Q)/F. Because the maximum number of polygons the electronic device can render in a second is N, the frame rate is still F. However, assuming the number of polygons used to render the cow at the first level of detail is P, during the third time period of FIG. 1C, the number of polygons per frame is (N+M+P−Q)/F and the frame rate remains F. However, during the second time period of FIG. 1B, the house 110 and tree 152 are rendered with fewer polygons than could be used and appear blockier.

Thus, in various implementations, the distance thresholds used to select the level of detail of object can be chosen for a worst-case scenario (in which objects are rendered with less quality) or be subject to frame rate reductions (in which motion is rendered with less quality). Accordingly, in various implementations, the level of detail is dynamically selected based on the number of polygons that can be rendered and the number of polygons in the virtual environment at any given time.

FIG. 1D-1H illustrate the virtual environment 100 during a fourth time period subsequent to the third time period according to various implementations. Between the third time period and the fourth time period, the rendering perspective has not changed, but the house 110 is rendered at a lower level of detail. During the fourth time period, foreground objects, e.g., the rock 153, the grass tuft 154, and the cow 155 are rendered at a first (and highest) level of detail. During the fourth time period, the house 110 is rendered at third level of detail lower than the second level of detail in the second time period of FIG. 1B and the third time period of FIG. 1C.

In FIG. 1D, the level of detail of the house 110 is lowered by using a mesh with fewer polygons than the mesh used at the second level of detail. Thus, in FIG. 1D, the scallops of the roof 111 are even more angular.

In FIG. 1E, the level of detail of the house 110 is lowered by lowering the level of detail of a child object. In particular, the level of detail of the house 110 is lowered by lowering the level of detail of the door 120. Thus, in FIG. 1E, the door 120 no longer has a doorknob 121.

In FIG. 1F, the level of detail of the house 110 is lowered by forgoing the rendering of a child object. In particular, the level of detail of the house 110 is lowered by forgoing rendering of the chair 130. Thus, in FIG. 1F, the chair 130 is absent.

In FIG. 1G, the level of detail of the house 110 is lowered by replacing rendering of the house 110 with an imposter image 161. Thus, in FIG. 1G, the house 110 is replaced with the imposter image 161. It is to be appreciated that the dashed border of the imposter image 161 is shown in FIG. 1G for the purpose of illustration and is not part of the virtual environment 100.

In FIG. 1H, the level of detail of the house 110 is lowered by replacing rendering of the house 110 and the rendering of the tree 152 with a group imposter image 162. Thus, in FIG. 1H, the house 110 and the tree 152 are replaced with the group imposter image 162. It is to be appreciated that the dashed border of the group imposter image 162 is shown in FIG. 1H for the purpose of illustration and is not part of the virtual environment 100.

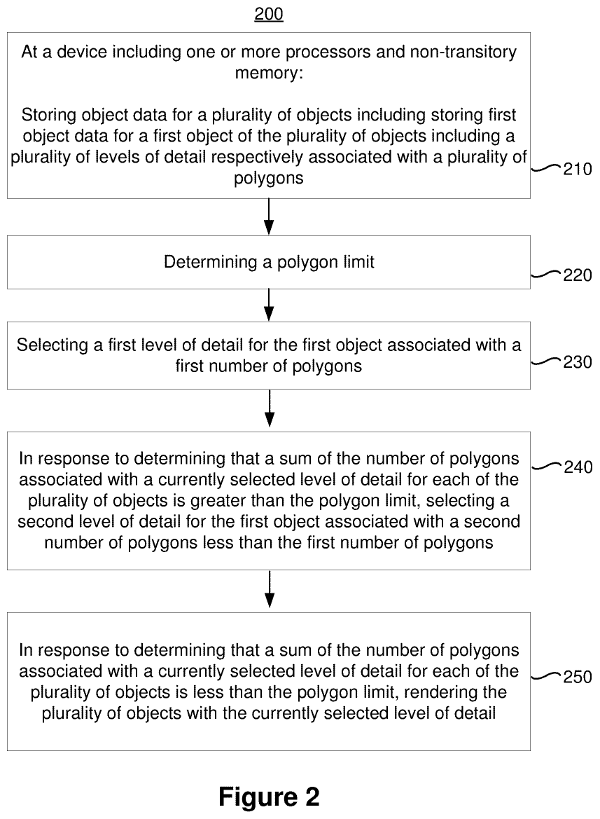

FIG. 2 is a flowchart representation of a method 200 of rendering objects in accordance with some implementations. In various implementations, the method 200 is performed by an electronic device. In various implementations, the method 200 is performed by a device one or more processors and non-transitory memory. In some implementations, the method 200 is performed by processing logic, including hardware, firmware, software, or a combination thereof. In some implementations, the method 200 is performed by a processor executing instructions (e.g., code) stored in a non-transitory computer-readable medium (e.g., a memory).

The method 200 begins, in block 210, with the device storing object data for a plurality of objects including storing first object data for a first object of the plurality of objects including a plurality of levels of detail respectively associated with a plurality of number of polygons. In various implementations, the plurality of objects includes each object that will be displayed on a screen. In various implementations, each of the plurality of objects is associated with multiple levels of detail. However, in some implementations, certain objects may only have one level of detail.

The method 200 continues, in block 220, with the device determining a polygon limit. In various implementations, the polygon limit is the number of polygons the device can render in a single frame period of a target frame rate. In various implementations, the polygon limit is a known parameter of the processor. However, in various implementations, the polygon limit can vary due to current processing conditions of the processor. Accordingly, in various implementations, determining the polygon limit is performed empirically.

For example, in various implementations, the device monitors the current frame rate. If the current frame rate drops below the target frame rate, the device determines (over a time period ranging over any number of frame periods) the average number of polygons rendered per frame and the current frame rate. Then, the device determines the polygon limit by multiplying these numbers together and dividing by target frame rate.

Accordingly, in various implementations, determining the polygon limit is based on a target frame rate. In various implementations, determining the polygon limit is based on a current frame rate. In various implementations, determining the polygon limit is based on current processing conditions of the processor.

The method 200 continues, in block 230, with the device selecting a first level of detail for the first object associated with a first number of polygons. In various implementations, the device similarly selects a first level of detail for each of the other objects, each associated with a respective number of polygons.

The method 200 continues, in block 240, with the device, in response to determining that a sum of the number of polygons associated with a currently selected level of detail for each of the plurality of objects is greater than the polygon limit, selecting a second level of detail for the first object associated with a second number of polygons less than the first number of polygons.

As illustrated in FIGS. 1D-1H, the second level of detail may be associated with a lower number of polygons than the first level of detail in a number of ways. For example, the mesh of the object itself may have fewer polygons at the second level of detail than at the first level of detail. Thus, in various implementations, the first level of detail is associated with a first mesh of the first object having a third number of polygons and the second level of detail is associated with a second mesh of the first object having a fourth number of polygons. In various implementations, the third number of polygons is the first number of polygons and the fourth number of polygons is the second number of polygons. However, in various implementations, the first object has one or more child objects. Thus, the first object has a mesh of its own having the third number of polygons or the fourth number of polygons and the one or more child objects make up the remaining polygons (to add up to the first number of polygons or the fourth number of polygons). For example, in FIG. 1D as compared to FIG. 1C, the number of polygons of the mesh of the house 110 is reduced. However, the mesh of the door 120 and the mesh of the chair 130 is unchanged.

Relatedly, the second level of detail may be associated with a lower number of polygons than the first level of detail by changing the mesh of a child object of the first object. Thus, in various implementations, the first level of detail is associated with a first mesh of a child object of the first object having a third number of polygons and the second level of detail is associated with a second mesh of the child object of the first object having a fourth number of polygons. For example, in FIG. 1E as compared to FIG. 1C, the number of polygons of the mesh of the door 120 is reduced, reducing the number of polygons of the house 110 although the mesh of the house 110 is unchanged.

Similarly, in various implementations, the second level of detail may be associated with a lower number of polygons than the first level of detail by forgoing the rendering of a child object. Thus, in various implementations, the first level of detail is associated with a mesh of a child object of the first object having a third number of polygons and the second level of detail is not associated with a mesh of the child object of the first object. For example, in FIG. 1F as compared to FIG. 1C, the chair 130 is not rendered, reducing the number of polygons of the house 110 although the mesh of the house 110 is unchanged.

In various implementations, the second level of detail is associated with an imposter image, greatly reducing the number of polygons of the object. Thus, in various implementations, the first level of detail is associated with a mesh of the first object having a third number of polygons and the second level of detail is associated with an imposter image of the first object. For example, in FIG. 1G as compared to FIG. 1C, the house 110 is replaced with the imposter image 161. In various implementations, the first level of detail is associated with a first mesh of the first object having a third number of polygons and a second mesh of a second object of the plurality of objects having a fourth number of polygons and the second level of detail is associated with a group imposter image of the first object and the second object. For example, in FIG. 1H as compared to FIG. 1C, the house 110 and the tree 152 are replaced with the group imposter image 162.

The method 200 continues, in block 250, with the device, in response to determining that the sum of the number of polygons associated with the currently selected level of detail for each of the plurality of object is less than the polygon limit, rendering the plurality of objects with the currently selected level of detail. In various implementations, the method 200 includes displayed the rendered objects.

In various implementations, the method 200 includes selecting a second level of detail for one or more objects and/or selecting a third level of detail for the first object and/or other objects until the sum of the number of polygons associated with the currently selected level of detail for each of the plurality of objects is less than the polygon limit. Thus, in various implementations, the method 200 selecting a first level of detail for a second object of the plurality of objects associated with a third number of polygons and, in response to determining that the sum of the number of polygons associated with the currently selected level of detail for each of the plurality of objects is greater than the polygon limit, selecting a second level of detail for the second object associated with a fourth number of polygons less than the third number of polygons. Similarly, in various implementations, the method 200 includes, in response to determining that the sum of the number of polygons associated with the currently selected level of detail for each of the plurality of objects is greater than the polygon limit, selecting a third level of detail for the first object associated with a third number of polygons less than the second number of polygons.

Just as lowering the level of detail of an object can be performed in a number of ways, selecting which object (or objects) have their level of detail lowered can also be performed in a number of ways. For example, in various implementations, the first object selected to have its level of detail lowered is the object furthest from the perspective of the rendering. Then, if the sum of the number of polygons is still too high, the second object selected to have its level of detail lowered is the object second furthest from the perspective. However, other selection schemes can be used, e.g., based on the number of polygons of each object, a size of each object, a priority of each object, etc. Thus, in various implementations, the method 200 includes, in response to determining that a sum of the number of polygons associated with a currently selected level of detail for each of the plurality of objects is greater than the polygon limit, selecting the first object from the plurality of objects. In various implementations, selecting the first object from the plurality of objects is based on a distance to the first object from a perspective of the rendering.

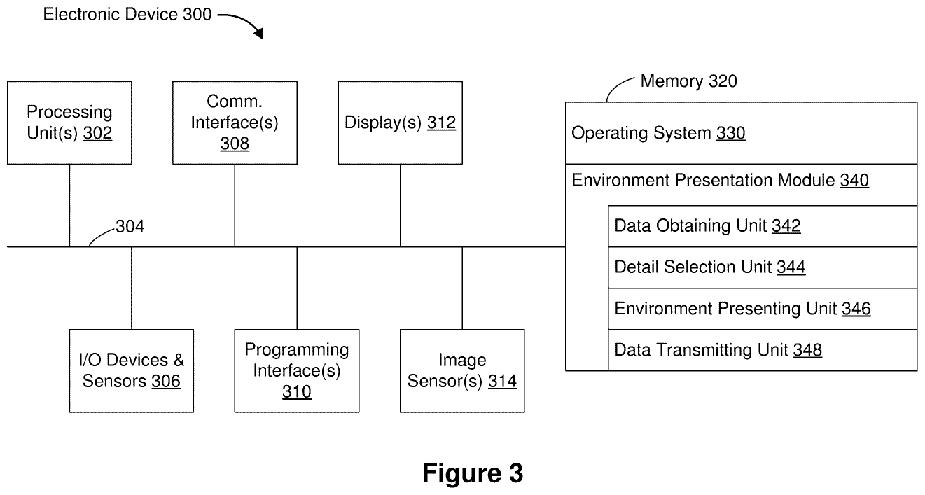

FIG. 3 is a block diagram of an example of an electronic device 300 in accordance with some implementations. While certain specific features are illustrated, those skilled in the art will appreciate from the present disclosure that various other features have not been illustrated for the sake of brevity, and so as not to obscure more pertinent aspects of the implementations disclosed herein. To that end, as a non-limiting example, in some implementations the electronic device 300 includes one or more processing units 302 (e.g., microprocessors, ASICs, FPGAs, GPUs, CPUs, processing cores, and/or the like), one or more input/output (I/O) devices and sensors 306, one or more communication interfaces 308 (e.g., USB, FIREWIRE, THUNDERBOLT, IEEE 802.3x, IEEE 802.11x, IEEE 802.16x, GSM, CDMA, TDMA, GPS, IR, BLUETOOTH, ZIGBEE, and/or the like type interface), one or more programming (e.g., I/O) interfaces 310, one or more displays 312, one or more optional interior-and/or exterior-facing image sensors 314, a memory 320, and one or more communication buses 304 for interconnecting these and various other components.

In some implementations, the one or more communication buses 304 include circuitry that interconnects and controls communications between system components. In some implementations, the one or more I/O devices and sensors 306 include at least one of an inertial measurement unit (IMU), an accelerometer, a gyroscope, a thermometer, one or more physiological sensors (e.g., blood pressure monitor, heart rate monitor, blood oxygen sensor, blood glucose sensor, etc.), one or more microphones, one or more speakers, a haptics engine, one or more depth sensors (e.g., a structured light, a time-of-flight, or the like), and/or the like.

In some implementations, the one or more displays 312 are configured to display a virtual environment. In some implementations, the one or more displays 312 correspond to holographic, digital light processing (DLP), liquid-crystal display (LCD), liquid-crystal on silicon (LCoS), organic light-emitting field-effect transitory (OLET), organic light-emitting diode (OLED), surface-conduction electron-emitter display (SED), field-emission display (FED), quantum-dot light-emitting diode (QD-LED), micro-electro-mechanical system (MEMS), and/or the like display types. In some implementations, the one or more displays 312 correspond to diffractive, reflective, polarized, holographic, etc. waveguide displays. In one example, the electronic device 300 includes a single display. In another example, the electronic device includes a display for each eye of the user. In some implementations, the one or more displays 312 are capable of presenting XR (extended reality) and VR (virtual reality) content.

In some implementations, the one or more image sensors 314 are configured to obtain image data that corresponds to at least a portion of the face of the user that includes the eyes of the user (any may be referred to as an eye-tracking camera). In some implementations, the one or more image sensors 314 are configured to be forward-facing so as to obtain image data that corresponds to the physical environment as would be viewed by the user if the electronic device 300 was not present (and may be referred to as a scene camera). The one or more optional image sensors 314 can include one or more RGB cameras (e.g., with a complimentary metal-oxide-semiconductor (CMOS) image sensor or a charge-coupled device (CCD) image sensor), one or more infrared (IR) cameras, one or more event-based cameras, and/or the like.

The memory 320 includes high-speed random-access memory, such as DRAM, SRAM, DDR RAM, or other random-access solid-state memory devices. In some implementations, the memory 320 includes non-volatile memory, such as one or more magnetic disk storage devices, optical disk storage devices, flash memory devices, or other non-volatile solid-state storage devices. The memory 320 optionally includes one or more storage devices remotely located from the one or more processing units 302. The memory 320 comprises a non-transitory computer readable storage medium. In some implementations, the memory 320 or the non-transitory computer readable storage medium of the memory 320 stores the following programs, modules and data structures, or a subset thereof including an optional operating system 330 and an environment presentation module 340.

The operating system 330 includes procedures for handling various basic system services and for performing hardware dependent tasks. In some implementations, the environment presentation module 340 is configured to present an environment to the user via the one or more displays 312. To that end, in various implementations, the environment presentation module 340 includes a data obtaining unit 342, a detail selection unit 344, an environment presenting unit 346, and a data transmitting unit 348.

In some implementations, the data obtaining unit 342 is configured to obtain data (e.g., presentation data, interaction data, sensor data, location data, etc.) from the other components of the electronic device 300 and/or a different electronic device. To that end, in various implementations, the data obtaining unit 342 includes instructions and/or logic therefor, and heuristics and metadata therefor.

In some implementations, the detail selection unit 344 is configured to select a level of detail for each of a plurality of objects such that the sum of the number of polygons of the objects at the selected level of detail is below a polygon limit. To that end, in various implementations, the detail selection unit 344 includes instructions and/or logic therefor, and heuristics and metadata therefor.

In some implementations, the environment presenting unit 346 is configured to display a rendering of the objects at the selected levels of detail. To that end, in various implementations, the environment presenting unit 346 includes instructions and/or logic therefor, and heuristics and metadata therefor.

In some implementations, the data transmitting unit 348 is configured to transmit data (e.g., presentation data, location data, etc.) to other components of the electronic device 300 and/or a different electronic device. To that end, in various implementations, the data transmitting unit 348 includes instructions and/or logic therefor, and heuristics and metadata therefor.

Although the data obtaining unit 342, the detail selection unit 344, the environment presenting unit 346, and the data transmitting unit 348 are shown as residing on a single device (e.g., the electronic device 300), it should be understood that in other implementations, any combination of the data obtaining unit 342, the detail selection unit 344, the environment presenting unit 346, and the data transmitting unit 348 may be located in separate computing devices.

Moreover, FIG. 3 is intended more as a functional description of the various features that could be present in a particular implementation as opposed to a structural schematic of the implementations described herein. As recognized by those of ordinary skill in the art, items shown separately could be combined and some items could be separated. For example, some functional modules shown separately in FIG. 3 could be implemented in a single module and the various functions of single functional blocks could be implemented by one or more functional blocks in various implementations. The actual number of modules and the division of particular functions and how features are allocated among them will vary from one implementation to another and, in some implementations, depends in part on the particular combination of hardware, software, and/or firmware chosen for a particular implementation.

While various aspects of implementations within the scope of the appended claims are described above, it should be apparent that the various features of implementations described above may be embodied in a wide variety of forms and that any specific structure and/or function described above is merely illustrative. Based on the present disclosure one skilled in the art should appreciate that an aspect described herein may be implemented independently of any other aspects and that two or more of these aspects may be combined in various ways. For example, an apparatus may be implemented and/or a method may be practiced using any number of the aspects set forth herein. In addition, such an apparatus may be implemented and/or such a method may be practiced using other structure and/or functionality in addition to or other than one or more of the aspects set forth herein.

It will also be understood that, although the terms “first,” “second,” etc. may be used herein to describe various elements, these elements should not be limited by these terms. These terms are only used to distinguish one element from another. For example, a first node could be termed a second node, and, similarly, a second node could be termed a first node, which changing the meaning of the description, so long as all occurrences of the “first node” are renamed consistently and all occurrences of the “second node” are renamed consistently. The first node and the second node are both nodes, but they are not the same node.

The terminology used herein is for the purpose of describing particular implementations only and is not intended to be limiting of the claims. As used in the description of the implementations and the appended claims, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” may be construed to mean “when” or “upon” or “in response to determining” or “in accordance with a determination” or “in response to detecting,” that a stated condition precedent is true, depending on the context. Similarly, the phrase “if it is determined [that a stated condition precedent is true]” or “if [a stated condition precedent is true]” or “when [a stated condition precedent is true]” may be construed to mean “upon determining” or “in response to determining” or “in accordance with a determination” or “upon detecting” or “in response to detecting” that the stated condition precedent is true, depending on the context.

What is claimed is:

1. A method comprising:
at a device having one or more processors and non-transitory memory:
storing object data for a plurality of objects including storing first object data for a first object of the plurality of objects including a plurality of levels of detail respectively associated with a plurality of number of polygons;
determining a polygon limit;
selecting a first level of detail for the first object associated with a first number of polygons;
in response to determining that a sum of the number of polygons associated with a currently selected level of detail for each of the plurality of objects is greater than the polygon limit, selecting a second level of detail for the first object associated with a second number of polygons less than the first number of polygons; and
in response to determining that the sum of the number of polygons associated with the currently selected level of detail for each of the plurality of objects is less than the polygon limit, rendering the plurality of objects with the currently selected level of detail.

2. The method of claim 1, wherein the first level of detail is associated with a first mesh of the first object having a third number of polygons and the second level of detail is associated with a second mesh of the first object having a fourth number of polygons.

3. The method of claim 1, wherein the first level of detail is associated with a first mesh of a child object of the first object having a third number of polygons and the second level of detail is associated with a second mesh of the child object of the first object having a fourth number of polygons.

4. The method of claim 1, wherein the first level of detail is associated with a mesh of a child object of the first object having a third number of polygons and the second level of detail is not associated with a mesh of the child object of the first object.

5. The method of claim 1, wherein the first level of detail is associated with a mesh of the first object having a third number of polygons and the second level of detail is associated with an imposter image of the first object.

6. The method of claim 1, wherein the first level of detail is associated with a first mesh of the first object having a third number of polygons and a second mesh of a second object of the plurality of objects having a fourth number of polygons and the second level of detail is associated with a group imposter image of the first object and the second object.

7. The method of claim 1, further comprising, in response to determining that a sum of the number of polygons associated with a currently selected level of detail for each of the plurality of objects is greater than the polygon limit, selecting the first object from the plurality of objects.

8. The method of claim 7, wherein selecting the first object from the plurality of objects is based on a distance to the first object from a perspective of the rendering.

9. The method of claim 1, further comprising:
selecting a first level of detail for a second object of the plurality of objects associated with a third number of polygons; and
in response to determining that the sum of the number of polygons associated with the currently selected level of detail for each of the plurality of objects is greater than the polygon limit, selecting a second level of detail for the second object associated with a fourth number of polygons less than the third number of polygons.

10. The method of claim 1, further comprising:
in response to determining that the sum of the number of polygons associated with the currently selected level of detail for each of the plurality of objects is greater than the polygon limit, selecting a third level of detail for the first object associated with a third number of polygons less than the second number of polygons.

11. The method of claim 1, wherein determining the polygon limit is based on a target frame rate.

12. The method of claim 11, wherein determining the polygon limit is based on a current frame rate.

13. The method of claim 11, wherein determining the polygon limit is based on current processing conditions of the processor.

14. A device comprising:
a non-transitory memory; and
one or more processors to:
store object data for a plurality of objects including storing first object data for a first object of the plurality of objects including a plurality of levels of detail respectively associated with a plurality of number of polygons;
determining a polygon limit;
select a first level of detail for the first object associated with a first number of polygons;
in response to determining that a sum of the number of polygons associated with a currently selected level of detail for each of the plurality of objects is greater than the polygon limit, select a second level of detail for the first object associated with a second number of polygons less than the first number of polygons; and
in response to determining that the sum of the number of polygons associated with the currently selected level of detail for each of the plurality of objects is less than the polygon limit, render the plurality of objects with the currently selected level of detail.

15. The device of claim 14, wherein the first level of detail is associated with a first mesh of the first object having a third number of polygons and the second level of detail is associated with a second mesh of the first object having a fourth number of polygons.

16. The device of claim 14, wherein the one or more processors are further to, in response to determining that a sum of the number of polygons associated with a currently selected level of detail for each of the plurality of objects is greater than the polygon limit, select the first object from the plurality of objects.

17. The device of claim 16, wherein the one or more processors are to select the first object from the plurality of objects based on a distance to the first object from a perspective of the rendering.

18. The device of claim 14, wherein the one or more processors are further to:
in response to determining that the sum of the number of polygons associated with the currently selected level of detail for each of the plurality of objects is greater than the polygon limit, selecting a third level of detail for the first object associated with a third number of polygons less than the second number of polygons.

19. The device of claim 14, wherein the one or more processors are to determine the polygon limit based on a target frame rate.

20. A non-transitory memory storing one or more programs, which, when executed by one or more processors of a device, cause the device to:
store object data for a plurality of objects including storing first object data for a first object of the plurality of objects including a plurality of levels of detail respectively associated with a plurality of number of polygons;
determine a polygon limit;
select a first level of detail for the first object associated with a first number of polygons;
in response to determining that a sum of the number of polygons associated with a currently selected level of detail for each of the plurality of objects is greater than the polygon limit, select a second level of detail for the first object associated with a second number of polygons less than the first number of polygons; and
in response to determining that the sum of the number of polygons associated with the currently selected level of detail for each of the plurality of objects is less than the polygon limit, render the plurality of objects with the currently selected level of detail.
